(19) United States
(12) Patent Application Publication
(10) Pub. No.: US 2026/0086670 A1
(43) Pub. Date: Mar. 26, 2026

(54) Touch Panel and Display Device Including the Same

(71) Applicant: LG Display Co., Ltd., Xdoul (KR)

(72) Inventors: Injun Lee, Gimpo-si (KR); Hae Yoon Jung, Seoul (KR); Aesun Kim, Paju-si (KR); MyungSub Lim, Seoul (KR); YuRa Jeong, Seoul (KR)

(21) Appl. No.: 19/280,955

(22) Filed: Jul. 25, 2025

(30) Foreign Application Priority Data
Sep. 24, 2024 (KR) 10-2024-0129204

(51) Int. Cl. G06F 3/041

(52) U.S. Cl. CPC G06F 3/04164; G06F 2203/04102

(57) ABSTRACT

A touch panel includes a base substrate including an active area and a non-active area excluding the active area; a plurality of touch sensing films which is disposed on the active area of the base substrate and is disposed so as to correspond to a touch sensing area; a plurality of touch lines which is disposed on the active area of the base substrate and at least partially overlaps the plurality of touch sensing films; a plurality of routing lines which is disposed on the non-active area of the base substrate and is connected to the plurality of touch lines; and a plurality of link lines which is disposed on the non-active area of the base substrate and connects the plurality of routing lines and a touch circuit unit. An end of each of the plurality of link lines includes a recess which is at least partially dented.

### CROSS-REFERENCE TO RELATED APPLICATION

This application claims the priority of Republic of Korea Patent Application No. 10-2024-0129204 filed on Sep. 24, 2024, which is hereby incorporated by reference in its entirety.

### BACKGROUND

### Field

The present disclosure relates to a touch panel and a display device including the same, and more particularly, to a stretchable touch panel and a display device including the same.

### Description of the Related Art

As display devices which are used for a monitor of a computer, a television, or a cellular phone, there are an organic light emitting display device (OLED) which is a self-emitting device and a liquid crystal display device (LCD) which requires a separate light source.

An applicable range of the display device is diversified to personal digital assistants as well as monitors of computers and televisions and a display device with a large display area and a reduced volume and weight is being studied.

Recently, a display device which is manufactured by forming a display unit and a wiring line on a flexible substrate such as plastic which is a flexible material so as to be stretchable in a specific direction and changed in various forms is getting attention as a next generation display device.

In the meantime, the touch panel is an input device in which a plurality of touch electrodes is disposed. Therefore, when a person's hand or an object touches the touch panel, the touch panel recognizes the position. In accordance with the development of smart devices, an applicable range and requirements of the touch panel are expanding. For example, when the touch panel is applied to a stretchable display device which attracts attention as a next-generation display device, it is necessary to ensure the stretching reliability of the touch panel.

### SUMMARY

An object to be achieved by the present disclosure is to provide a touch panel with an improved stretching reliability and a display device including the same.

Another object to be achieved by the present disclosure is to provide a touch panel which is stretchable in various directions and a display device including the same.

Objects of the present disclosure are not limited to the above-mentioned objects, and other objects, which are not mentioned above, can be clearly understood by those skilled in the art from the following descriptions.

In order to achieve the above-described objects, according to an embodiment of the present disclosure, a touch panel may include a base substrate including an active area and a non-active area excluding the active area, a plurality of touch sensing films which is disposed on the active area of the base substrate and is disposed so as to correspond to a touch sensing area, a plurality of touch lines which is disposed on the active area of the base substrate and at least partially overlaps the plurality of touch sensing films, a plurality of routing lines which is disposed on the non-active area of the base substrate and is connected to the plurality of touch lines, and a plurality of link lines which is disposed on the non-active area of the base substrate and connects the plurality of routing lines and a touch circuit unit and an end of each of the plurality of link lines may include a recess which is at least partially dented.

In order to achieve the above-described objects, according to an embodiment of the present disclosure, a touch panel may include a base substrate including an active area and a non-active area excluding the active area, a plurality of touch sensing films which is disposed on the active area of the base substrate and is disposed so as to correspond to a touch sensing area, a plurality of touch lines which is disposed on the active area of the base substrate and at least partially overlaps the plurality of touch sensing films, a plurality of routing lines which is disposed on the non-active area of the base substrate and is connected to the plurality of touch lines, a plurality of link lines which is disposed on the non-active area of the base substrate and connects the plurality of routing lines and a touch circuit unit, and a line connection part which connects one end of each of the plurality of link lines and the plurality of routing lines. The line connection part may include a main connection part which is connected to each of the plurality of routing lines; and at least one sub connection part which connects the main connection part and one end of each of the plurality of link lines.

In order to achieve the above-described objects, according to an embodiment of the present disclosure, a display device may include a display panel including a flexible lower substrate and a plurality of plate patterns which is rigider than the lower substrate and disposed on the lower substrate to be spaced apart from each other and a touch panel which is disposed on the display panel and includes a plurality of touch lines, a plurality of routing lines connected to the plurality of touch lines, and a plurality of link lines which connects the plurality of routing lines and a touch circuit unit and an end of each of the plurality of link lines may include a recess which is at least partially dented.

Other detailed matters of the exemplary embodiments are included in the detailed description and the drawings.

According to the exemplary embodiments of the present disclosure, in the touch panel and the display device including the same, a routing line and a link line which are disposed in a non-active area of the touch panel to transmit a touch signal to a touch circuit unit may be connected by a line connection part. The line connection part includes a main connection part which is connected to the routing line and has a planar structure and at least one sub connection part which connects the main connection part and the link line and has a curved line structure. Therefore, when the touch panel and the display device including the same are stretched, a stretching stress applied to the connection part of the routing line and the link line and/or the routing line may be distributed or reduced. Accordingly, the stretching reliability of the touch panel and the display device including the same according to the exemplary embodiments of the present disclosure may be improved.

Further, according to the exemplary embodiments of the present disclosure, in the touch panel and the display device including the same, the routing line and the link line may be connected by a line connection part. The line connection part includes a main connection part which is connected to the routing line and has a planar structure and a plurality of sub connection parts which connects the main connection part and the link line and has a curved line structure, and extends in different directions. Accordingly, even though the touch panel is stretched in various directions, rather than a specific one direction, the stretching stress to be applied to the connection part of the routing line and the link line and/or the routing line may be dispersed so that the stretching reliability of the touch panel and the display device including the same may be ensured.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is an exploded perspective view schematically illustrating a display device according to exemplary embodiments of the present disclosure;

FIG. 2 is a plan view illustrating an example of a display panel included in a display device of FIG. 1 according to exemplary embodiments of the present disclosure;

FIG. 3 is a perspective view illustrating an example of a touch panel included in a display device of FIG. 1 according to exemplary embodiments of the present disclosure;

FIG. 4 is an enlarged plan view illustrating an example of a part B of FIG. 3 according to exemplary embodiments of the present disclosure;

FIG. 5 is a perspective view illustrating another example of a touch panel included in a display device of FIG. 1 according to exemplary embodiments of the present disclosure;

FIG. 6 is an enlarged plan view illustrating an example of a part C of FIG. 5 according to exemplary embodiments of the present disclosure;

FIG. 7 is an enlarged plan view illustrating an example of a part D of FIG. 3 according to exemplary embodiments of the present disclosure;

FIG. 8 is a view for explaining an example of a line connection part included in a touch panel of FIG. 3 according to exemplary embodiments of the present disclosure;

FIG. 9 is a view for explaining another example of a line connection part included in a touch panel of FIG. 3 according to exemplary embodiments of the present disclosure;

FIG. 10 is a view for explaining still another example of a line connection part included in a touch panel of FIG. 3 according to exemplary embodiments of the present disclosure;

FIG. 11 is a view for explaining still another example of a line connection part included in a touch panel of FIG. 3 according to exemplary embodiments of the present disclosure;

FIG. 12 is a view for explaining still another example of a line connection part included in a touch panel of FIG. 3 according to exemplary embodiments of the present disclosure;

FIG. 13 is a view for explaining still another example of a line connection part included in a touch panel of FIG. 3 according to exemplary embodiments of the present disclosure; and

FIGS. 14A to 14G are views for explaining examples of a stretching stress applied to a routing line included in a touch panel when a display device according to exemplary embodiments of the present disclosure is stretched.

### DETAILED DESCRIPTION

When the relation of a time sequential order is described using the terms such as “after”, “continuously to”, “next to”, and “before”, the order may not be continuous unless the terms are used with the term “immediately”or “directly”.

In describing components of the exemplary embodiment of the present disclosure, terminologies such as first, second, A, B, (a), (b), and the like may be used. These terminologies are used to distinguish a component from the other component, but a nature, an order, or the number of the components is not limited by the terminology. When a component is “linked”, “coupled”, or “connected” to another component, the component may be directly linked or connected to the other component. However, unless specifically stated otherwise, it should be understood that a third component may be interposed between the components which may be indirectly linked or connected.

It should be understood that “at least one” includes all combinations of one or more of associated components. For example, “at least one of first, second, and third components” means that not only a first, second, or third component, but also all combinations of two or more of first, second, and third components are included.

In the present specification, a “display device” may include a display device which includes a display panel and a driver for driving the display panel, in a narrow sense, such as a liquid crystal module (LCM), an organic light emitting module (OLED module), and a quantum dot (QD) module. Further, the “display device” may further include a set electronic apparatus or a set apparatus (or a set device) which is a complete product or a final product including an LCM, an OLED module, a QD module, etc., such as a notebook computer, a television, or a computer monitor, an automotive display device or equipment display device including another type of vehicle and a mobile electronic apparatus including a smart phone or an electronic pad.

Accordingly, the display device of the present disclosure may include not only a display device itself in a narrow sense such as an LCM, an OLED module, a QD module, etc., but also an applied product or a set apparatus which is a final consumer device including the LCD, the OLED module, the QD module, etc.

Further, in some cases, the LCM, the OLED module, or the QD module which is configured by a display panel and a driver may be represented as “a display device” in a narrow sense and an electronic device as a complete product including the LCM, the OLED module, and the QD module may be represented as a “set apparatus”. For example, the display device in the narrow sense includes a liquid crystal (LCD) display panel, an OLED display panel, or a quantum dot display panel and a source PCB which is a controller for driving the display panel. In contrast, the set apparatus may be a concept further including a set PCB which is a set controller which is electrically connected to the source PCB to control the entire set apparatus.

As a display panel used in the exemplary embodiment of the present disclosure, any type of display panel such as a liquid crystal display panel, an organic light emitting diode (OLED) display panel, a quantum dot (QD) display panel, and an electroluminescent display panel may be used. The display panel of the present exemplary embodiment is not limited to a specific display panel in which a bezel is bent with a flexible substrate for the organic light emitting diode (OLED) display panel and a back plate support structure therebelow. Further, a display panel used for the display device according to the exemplary embodiment of the present disclosure is not limited to a shape or a size of the display panel.

For example, when the display panel is an OLED display panel, the display panel may include a plurality of gate lines, data lines, and pixels formed at intersecting areas of the gate lines and/or data lines. Further, the display panel may be configured to include an array including a thin film transistor which is an element to selectively apply a voltage to each pixel, a light emitting diode layer on the array, an encapsulation substrate or an encapsulation layer, and the like disposed on the array so as to cover the light emitting diode layer. The encapsulation layer may protect the thin film transistor the light emitting diode layer, and the like from external impacts and may suppress the permeation of moisture or oxygen into the light emitting diode layer. Further, a layer formed on the array may include an inorganic light emitting layer, for example, a nano-sized material layer quantum dots, or the like.

The features of various exemplary embodiments of the present disclosure can be partially or entirely coupled to or combined with each other and can be interlocked and operated in technically various ways, and the exemplary embodiments can be carried out independently of or in association with each other.

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Hereinafter, an exemplary embodiment of the present disclosure will be described in detail with reference to the drawings.

A display device according to exemplary embodiments of the present disclosure is a display device which is capable of displaying images even in a bent or extended state and may also be referred to as a stretchable display device, a flexible display device and an extendable display device. As compared with the general display devices of the related art, the display device has not only a high flexibility, but also stretchability. Therefore, the user may bend or extend a display device and a shape of a display device may be freely changed in accordance with manipulation of a user. For example, when the user pulls the display device by holding ends of the display device, the display device may be extended to the pulling direction of the user. Alternatively, when the user disposes the display device on an outer surface which is not flat, the display device may be disposed to be bent in accordance with the shape of the outer surface of the wall. Further, when a force applied by the user is removed, the display device may return to its original shape.

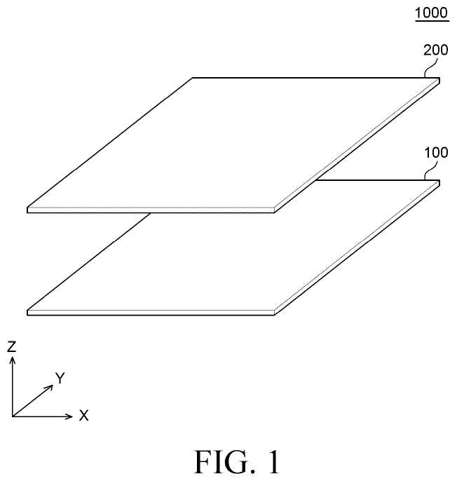

FIG. 1 is an exploded perspective view schematically illustrating a display device according to exemplary embodiments of the present disclosure.

Referring to FIG. 1, a display device 1000 according to the exemplary embodiments of the present disclosure may include a display panel 100 and a touch panel 200.

The display panel 100 may be extendable along any one of a first direction X or a second direction Y which is different from the first direction X or may be two-dimensionally extendable along the first direction X and the second direction Y.

In the meantime, for the convenience of description, hereinafter, a first length direction on the plane (for example, a horizontal direction) is illustrated as a first direction X and a second length direction on the plane (for example, a vertical direction) is illustrated as a second direction Y. For example, the plane defined by the first direction X and the second direction Y may be parallel to a plane of the display device 1000 and the second direction Y may be perpendicular to the first direction X. Further, a normal direction of a plane defined by the first direction X and the second direction Y, for example, a thickness direction of the display device 1000 may be defined as a third direction Z.

The touch panel 200 may be disposed above the display panel 100. For example, even though it is not illustrated in FIG. 1, the touch panel 200 may be bonded to the display panel 100 by an adhesive layer.

The touch panel 200 may be extendable along any one of the first direction X or the second direction Y or may be two-dimensionally extendable along the first direction X and the second direction Y.

In the meantime, even though in FIG. 1, the display panel 100 and the touch panel 200 are illustrated to have a rectangular shape with an angular corner, the exemplary embodiment of the present disclosure is not limited thereto.

For example, the display panel 100 and/or the touch panel 200 may have a chamfered shape with a cut corner. Generally, the stretchable display device is stretched by holding outermost upper and lower sides or outermost left and right sides. In this case, a deformed amount of the outermost edge of the display panel 100 and/or the touch panel 200 and a deformed amount of the center portion may be different. For example, the deformation occurring at the outermost upper and lower sides or left and right sides of the display panel 100 and/or the touch panel 200 may be larger than or smaller than the deformation occurring at the upper and lower sides or left and right sides of the center portion. That is, when the display device 1000 is stretched, vertical ratios of the outermost portion and the center portion of the display panel 100 and/or the touch panel 200 may be different. Accordingly, if the display panel 100 and/or the touch panel 200 has a chamfered shape with a cut corner, when the display panel 100 and/or the touch panel 200 is stretched, there is almost no difference between a length of the outermost upper and lower sides or left and right sides and a length of the upper and lower sides or left and right sides of the center portion. Therefore, the display panel 100 may provide a uniform image quality in any area and the touch panel 200 may sense a clearer touch signal which is not distorted.

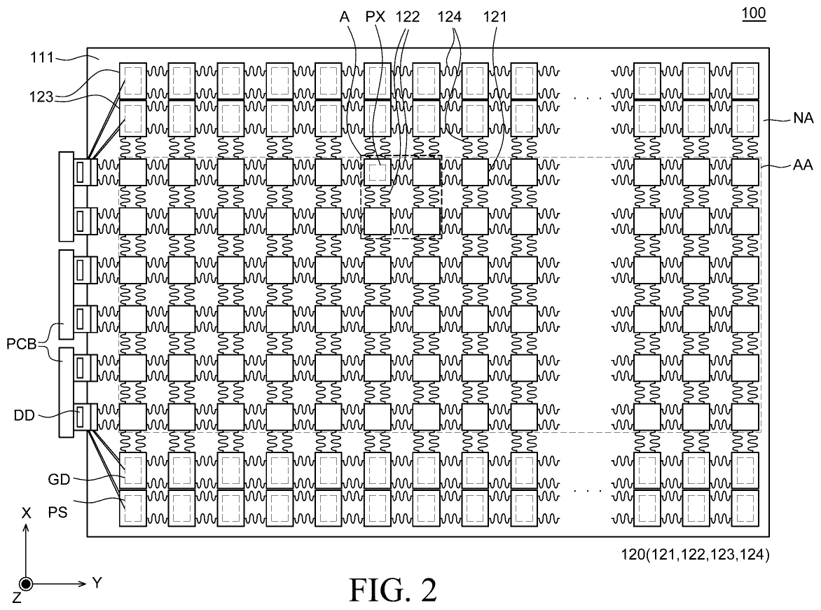

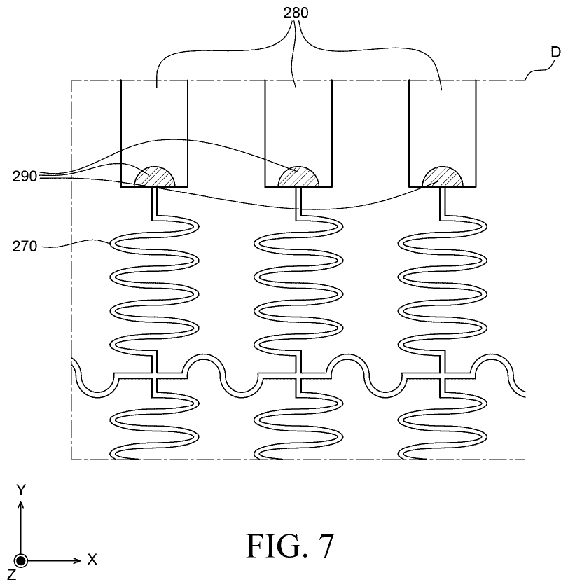

The display panel 100 of the display device 1000 as described above will be described in more detail with reference to FIGS. 2 to 6 and the touch panel 200 of the display device 1000 will be described in more detail with reference to FIGS. 7 to 14G.

FIG. 2 is a plan view illustrating an example of a display panel included in a display device of FIG. 1 according to exemplary embodiments of the present disclosure.

Referring to FIG. 2, a display panel 100 according to an exemplary embodiment of the present disclosure may include a lower substrate 111, a pattern layer 120, a plurality of pixels PX, a gate driver GD (e.g., a circuit), a data driver DD (e.g., a circuit), and a power supply PS (e.g., a circuit). In one exemplary embodiment, even though it is not illustrated in FIG. 2, the display panel 100 may further include an upper substrate which is opposite to the lower substrate 111 and is disposed on the top of the display panel 100.

The lower substrate 111 may support various components of the display panel 100 and the upper substrate may cover various components of the display panel 100.

In one exemplary embodiment, the lower substrate 111 and the upper substrate which are flexible substrates may include an insulating material which is bendable or extendable.

A modulus of elasticity of each of the lower substrate 111 and the upper substrate may be several MPa to several hundreds of MPa. According to the exemplary embodiment, a ductile breaking rate of each of the lower substrate 111 and the upper substrate may be 100% or higher. Here, the ductile breaking rate refers to a stretching rate at a timing when an object to be stretched is broken or cracked.

The lower substrate 111 may include an active area AA (or a display area) in which images are displayed and a non-active area NA (or a non-display area) excluding the active area AA. For example, on the active area AA, a plurality of pixels PX each including a display element and a circuit element is disposed and on the non-active area NA, a gate driver GD and a power supply PS for driving the plurality of pixels PX disposed in the active area AA may be disposed.

A pattern layer 120 may be disposed on the lower substrate 111 to be spaced apart from each other.

According to one exemplary embodiment, the pattern layer 120 may include a plurality of first plate patterns 121 and a plurality of first line patterns 122 disposed in the active area AA and a plurality of second plate patterns 123 and a plurality of second line patterns 124 disposed in the non-active area NA. For example, the plurality of first plate patterns 121 and the plurality of second plate patterns 123 which have been described above are formed in the form of separate islands. The plurality of first line patterns 122 may connect first plate patterns 121 which are adjacent to each other and the plurality of second line patterns 124 may connect a first plate pattern 121 and a second plate pattern 123 which are adjacent to each other or a plurality of second plate patterns 123 which is adjacent to each other.

The plurality of pixels PX may be formed on the plurality of first plate patterns 121 and on the gate driver GD and the power supply PS may be formed on the plurality of second plate patterns 123. Further, the plurality of connection lines may be disposed on the plurality of first line patterns 122 and the plurality of second line patterns 124.

In the meantime, even though in FIG. 2, it is illustrated that the plurality of first plate patterns 121 and the plurality of second plate patterns 123 have a quadrangular shape, it is not limited thereto.

The plurality of first line patterns 122 and the second line patterns 124 may have a curved shape (for example, a sine wave shape), but are not limited thereto. For example, the plurality of first line patterns 122 and the second line patterns 124 may extend in a zigzag pattern or may be formed with various shapes such as a shape extended by connecting a plurality of rhombus-shaped substrates at vertexes.

In one exemplary embodiment, the plurality of first plate patterns 121, the plurality of first line patterns 122, the plurality of second plate patterns 123, and the plurality of second line patterns 124 may be rigid patterns. For example, the plurality of first plate patterns 121, the plurality of first line patterns 122, the plurality of second plate patterns 123, and the plurality of second line patterns 124 may be more rigid than the lower substrate 111 and the upper substrate. Accordingly, moduli of elasticity and hardness of the plurality of first plate patterns 121, the plurality of first line patterns 122, the plurality of second plate patterns 123, and the plurality of second line patterns 124 may be higher than a modulus of elasticity and the hardness of the lower substrate 111. For example, moduli of elasticity of the plurality of first plate patterns 121, the plurality of first line patterns 122, the plurality of second plate patterns 123, and the plurality of second line patterns 124 may be 1000 times higher than the moduli of elasticity of the lower substrate 111 and the upper substrate, but it is not limited thereto.

The plurality of first plate patterns 121, the plurality of first line patterns 122, the plurality of second plate patterns 123, and the plurality of second line patterns 124 may be formed of a plastic material having a lower flexibility than the lower substrate 111 and the upper substrate.

The gate driver GD may supply a gate signal to the plurality of pixels PX disposed in the active area AA. The gate driver GD may include a plurality of stages formed on the plurality of second plate patterns 123 and each stage of the gate driver GD may be electrically connected to each other by means of the plurality of gate connection lines. Accordingly, a gate signal output from any one of stages may be transmitted to the other stage. Each stage may sequentially supply the gate signal to the plurality of pixels PX connected to each stage.

The power supply PS is connected to the gate driver GD to supply a gate driving voltage and a gate clock voltage. Further, the power supply PS is connected to the plurality of pixels PX to supply a pixel driving voltage to each of the plurality of pixels PX.

The printed circuit board PCB includes a controller, such as an IC chip or a circuit unit and/or a memory or a processor to transmit a signal and a voltage for driving the display element from the controller to the display element. The printed circuit board PCB may include a stretching area and a non-stretching area to ensure stretchability. For example, in the non-stretching area, an IC chip, a circuit unit, a memory, and a processor may be mounted and in the stretching area, wiring lines which are electrically connected to the IC chip, the circuit unit, the memory, and the processor may be disposed.

The data driver DD may supply a data voltage to the plurality of pixels PX disposed in the active area AA. The data driver DD may be configured as an IC chip so that it may also be referred to as a data integrated circuit D-IC.

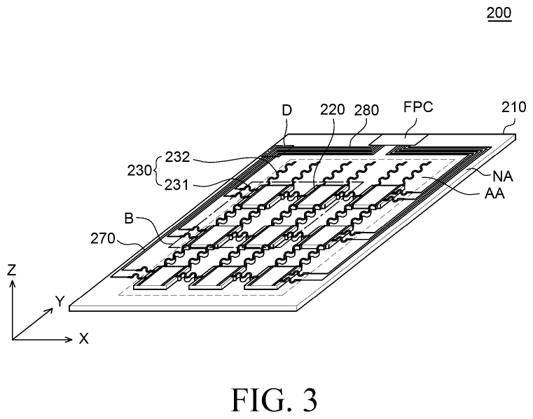

FIG. 3 is a perspective view illustrating an example of a touch panel included in a display device of FIG. 1 according to one embodiment.

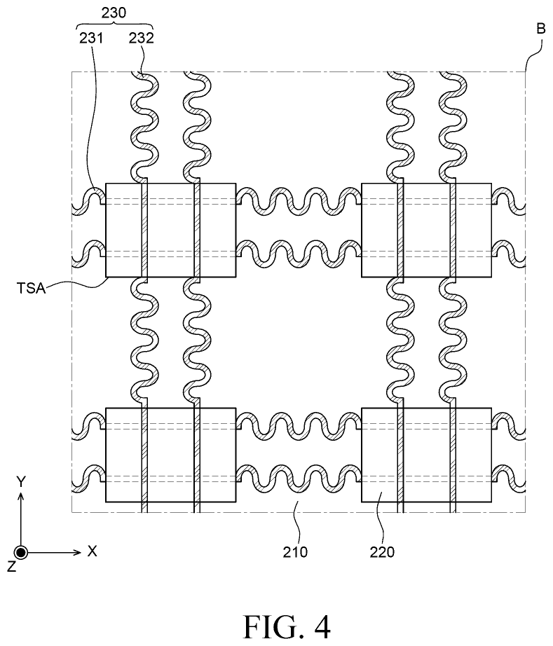

FIG. 4 is an enlarged plan view illustrating an example of a part B of FIG. 3 according to one embodiment.

Referring to FIGS. 3 and 4, the touch panel 200 according to the exemplary embodiment of the present disclosure may include a material which copes with the stretching of the display device 1000. The touch panel 200 is disposed on the display panel 100 and may have a shape corresponding to the display panel 100, for example, a shape corresponding to the lower substrate 111 of the display panel 100.

The touch panel 200 may include a base substrate 210 (or a touch base substrate), a plurality of touch sensing films 220 disposed on the base substrate 210, a plurality of touch lines 230, a plurality of routing lines 270, and a plurality of link lines 280. The plurality of touch lines 230 are arranged in the first direction X and the second direction Y on the base substrate 210 and the plurality of touch sensing films 220. The plurality of routing lines 270 are connected to the plurality of touch lines 230 to transmit a touch signal detected by the plurality of touch lines 230 and the plurality of link lines 280 connects the plurality of routing lines 270 and the touch circuit unit FPC.

The base substrate 210 may support the plurality of touch sensing films 220, the plurality of touch lines 230, the plurality of routing lines 270, and the plurality of link lines 280. The base substrate 210 may include an active area AA and a non-active area NA excluding the active area AA. For example, the non-active area NA may enclose the active area AA. The active area AA of the base substrate 210 may be an area in which the plurality of touch sensing films 220 and the plurality of touch lines 230 to be described below are disposed to detect a touch (for example, a user's touch) input from the outside. Further, the non-active area NA is an area in which the user's touch is not detected and the plurality of routing lines 270 and the plurality of link lines 280 are disposed to transmit the touch sensing signal sensed in the active area AA to the touch circuit unit FPC. According to the exemplary embodiment, the active area AA and the non-active area NA of the base substrate 210 may overlap the active area AA and the non-active area NA of the display panel 100 which have been described with respect to FIG. 2, respectively.

The base substrate 210 is a flexible substrate so as to be reversibly expanded and contracted. For example, the base substrate 210 may include a stretchable flexible material. For example, the base substrate 210 may include the same material as the lower substrate 111 of the display panel 100.

In one exemplary embodiment, the base substrate 210 may include an insulation material which is bendable or extendable. For example, the base substrate 210 may include a silicon rubber such as polydimethylsiloxane (PDMS) and an elastomer such as polyurethane. Accordingly, the base substrate 210 may have a flexible property. However, the material of the base substrates 210 is not limited thereto.

Further, a modulus of elasticity of the base substrate 210 may be several MPa to several hundreds of MPa. According to the exemplary embodiment, a ductile breaking rate of the base substrate 210 may be 100% or higher.

The plurality of touch sensing films 220 may be disposed on the active area AA of the base substrate 210 to be spaced apart from each other with a predetermined distance. In one exemplary embodiment, a size of each of the plurality of touch sensing films 220 may correspond to a size of each of the plurality of first plate patterns 121 disposed on the display panel 100 which has been described with reference to FIG. 2. For example, the size of each of the plurality of touch sensing films 220 may be equal to the size of each of the plurality of first plate patterns 121.

In one exemplary embodiment, the plurality of touch sensing films 220 may include a touch sensing material. For example, the plurality of touch sensing films 220 may include a touch base film which is formed of a bendable or extendable insulating material and a touch sensing material which is dispersed in the touch base film in the form of particles.

The touch base film of the touch sensing film 220 may include the same material as the base substrate 210 and/or the lower substrate 111 of the display panel 100. For example, the touch base film of the touch sensing film 220 may include a silicon rubber such as polydimethylsiloxane (PDMS) and an elastomer such as polyurethane, but is not limited thereto. For example, the touch base film of the touch sensing film 220 may be formed of a plastic material having a flexibility lower than that of the base substrate 210 and/or the lower substrate 111 of the display panel 100. For example, the touch base film of the touch sensing film 220 may include the same material as the plurality of first plate patterns 121, the plurality of first line patterns 122, the plurality of second plate patterns 123, and the plurality of second line patterns 124, which have been described with reference to FIG. 2. For example, the touch base film of the touch sensing film 220 may include at least one material of polyimide (PI), polyacrylate, and polyacetate.

The touch sensing material of the touch sensing film 220 may include at least one of piezo metal and piezo polymer.

In the meantime, it has been described above that the touch sensing film 220 includes the touch base film and the touch sensing material which is dispersed in the touch base film in the form of particles, the present disclosure is not limited thereto and the touch sensing film 220 may be formed with only a stretchable piezo film.

A plurality of touch lines 230 may be disposed below and above the touch sensing film 220 to sense the touch.

The plurality of touch lines 230 extend to each of the first direction X and the second direction Y on the active area AA of the base substrate 210. For example, the plurality of touch lines 230 may include a plurality of first touch lines 231 which are disposed along the first direction X and the plurality of second touch lines 232 are disposed along the second direction Y on the active area AA of the base substrate 210. For example, as illustrated in FIGS. 3 and 4, the plurality of first touch lines 231 and the plurality of second touch lines 232 may be disposed so as to intersect each other.

The touch sensing film 220 may be interposed between the plurality of first touch lines 231 and the plurality of second touch lines 232. For example, the plurality of touch sensing films 220 may be disposed in an area in which the plurality of first touch lines 231 disposed in the first direction X and the plurality of second touch lines 232 disposed in the second direction Y intersect. That is, the plurality of first touch lines 231 and the plurality of second touch lines 232 may overlap the plurality of touch sensing films 220 in at least a part (for example, an area where the first touch line 231 and the second touch line 232 intersect).

At this time, the intersecting area of the plurality of first touch lines 231 and the plurality of second touch lines 232 are defined as a touch sensing area TSA and the plurality of touch sensing films 220 may be disposed so as to correspond to the touch sensing area TSA, for example, so as to overlap the touch sensing area TSA. Accordingly, the touch panel 200 may sense a touch coordinate and a touch input using a resistance change of the touch sensing film 220 with respect to the touch input.

In one exemplary embodiment, the touch sensing area TSA may correspond to an area in which the first plate pattern 121 of the display panel 100 is disposed. For example, the touch sensing area TSA may overlap the first plate pattern 121, but is not limited thereto.

The plurality of touch lines 230 may include a transparent conductive material. For example, the plurality of touch lines 230 may include a transparent conductive material, such as indium-tin-oxide (ITO), a conductive polymer, or carbon nano tube.

In one exemplary embodiment, the plurality of touch lines 230 may have a curved shape in the first area of the base substrate 210 and have a straight line shape in the second area of the base substrate 210. Therefore, the first area may be defined as an area in which the plurality of touch sensing films 220 is not disposed, but the base substrate 210 is disposed and the second area may be defined as an area in which the touch sensing film 220 is disposed on the base substrate 210. For example, the second area may correspond to the touch sensing area TSA. That is, the plurality of touch lines 230 may have a straight line shape in an area which overlaps the plurality of touch sensing films 220, for example, the touch sensing area TSA, and a curved shape in the other area.

According to the exemplary embodiment, the curvature of the plurality of touch lines 230 which is disposed in the first area may be disposed to have a minute interval. For example, the curvature of the plurality of touch lines 230 disposed in the first area may have a fine pitch. Accordingly, the amount of curvature of the plurality of touch lines 230 disposed in the first area of the touch panel 200 may be larger than the amount of curvature of the plurality of connection lines disposed on the lower substrate 111 of the display panel 100. For example, when the plurality of connection lines which has been described with reference to FIG. 2 is formed to be curved n times, the plurality of touch lines 230 may be curved 2n times (n is a positive integer). Accordingly, the touch sensing area TSA of the touch panel 200 may be sufficiently ensured. To be more specific, when the number of being curved of the touch line 230 disposed in the first area is larger than the number of being curved of the connection line disposed in the display panel 100, the number of placements of the second area of the touch panel 200 which is straightly disposed, that is, the touch sensing area TSA may be increased. Alternatively, if the number of bends in the touch line 230 disposed in the first area of the touch panel 200 is larger than the number of being curved of the connection line disposed in the display panel 100, the second area of the touch panel 200 which is straightly disposed, that is, the touch sensing area TSA is disposed to be larger. Therefore, the touch sensing area TSA may be greatly increased. Accordingly, if the curved amount of the plurality of touch lines 230 disposed in the first area is large, many touch sensing areas TSA may be formed or the touch sensing area TSA may be formed to be large so that clearer touch sensing may be achieved.

Further, in this case, the first plate pattern 121 of the display panel 100 and the second area of the touch panel 200 may be more easily aligned. The reason why the touch line 230 is disposed to have a curved shape in the first area of the base substrate 210 as described is to respond to the stretching of the touch panel 200. The reason why the touch line 230 is disposed in the second area to have a straight line shape is because when the touch line has a curved shape even in the second area, an error of the touch sensing signal due to the interference between the first touch line 231 and the second touch line 232 may occur. For example, in the second area, that is, the touch sensing area TSA, the first touch line 231 and the second touch line 232 intersect and the touch is sensed at the intersection. When the first touch line 231 and the second touch line 232 are curved, more intersections of the first touch line 231 and the second touch line 232 may be disposed than that of the straight line shape and the intersections may be disposed to be adjacent to cause the signal interference. However, the exemplary embodiment of the present disclosure is not limited thereto. The plurality of touch lines 230 may have a curved shape in all the areas to have a degree of curvature which does not cause the signal interference in the touch sensing area TSA. If the touch line 230 is formed of a material which responds to the stretching in the first area, the touch line may also be disposed to have a straight line shape in all the areas.

As described above, a plurality of touch sensing films 220 of the touch panel 200 of the display device 1000 according to the exemplary embodiments of the present disclosure is disposed to be spaced apart from each other on the base substrate 210 which is a flexible substrate and is disposed in an area overlapping the first plate pattern 121 of the display panel 100. By doing this, when the display panel 100 is stretched in both directions, the touch panel 200 may also be stretched in both directions.

Further, the touch sensing film 220 of the touch panel 200 may be located in an area between the first plate patterns 121 of the display panel 100 so that the sensing sensitivity of the touch position may be improved.

In the meantime, even though it is not illustrated in FIG. 3, in the non-active area NA of the touch panel 200, a plastic substrate formed of a material having flexibility may be further disposed above or below the base substrate 210. This is because a flexible connection film for electrical connection with the outside, for example, the touch circuit unit FPC may be disposed in the non-active area NA and the process of electrical connection with the touch circuit unit FPC is mostly configured by the high temperature process so that it is necessary to withstand it.

The plurality of routing lines 270 may be disposed on the non-active area NA of the base substrate 210. For example, the plurality of routing lines 270 may be disposed in the non-active area NA of the base substrate 210 on a first side (for example, a left side of the touch panel 200) of the active area AA and a second side (for example, a right side of the touch panel 200) which is opposite to the first side in the first direction X, respectively.

The plurality of routing lines 270 may be connected to the plurality of touch lines 230 disposed in the active area AA. Accordingly, a touch signal detected by the plurality of touch lines 230 may be transmitted to the plurality of routing lines 270.

The plurality of routing lines 270 may be formed of a transparent conductive material which is the same as a material which forms the plurality of touch lines 230 disposed in the active area AA, but is not limited thereto. Therefore, the plurality of routing lines may include an opaque material having a low resistance, such as molybdenum (Mo), silver (Ag), titanium (Ti), copper (Cu), or aluminum (Al).

According to the exemplary embodiment, the plurality of routing lines 270 may have a curved shape. Accordingly, the stretchability of the touch panel 200 may be ensured.

The plurality of link lines 280 may be disposed on the non-active area NA of the base substrate 210. For example, the plurality of link lines 280 may be disposed in the non-active area NA of the base substrate 210 on a third side (for example, above or below the touch panel 200) between the first side and the second side of the active area AA in which the plurality of routing lines 270 is disposed. For example, the plurality of link lines 280 may be disposed so as to correspond to an area of the non-active area NA in which the touch circuit unit FPC is disposed.

The plurality of link lines 280 may electrically connect the plurality of routing lines 270 and the touch circuit unit FPC. Accordingly, a touch signal which is detected from the plurality of touch lines 230 to be transmitted to the plurality of routing lines 270 may be transmitted to the touch circuit unit FPC through the plurality of link lines 280. Therefore, the touch circuit unit FPC may detect a touch (for example, a user's touch) input from the outside.

The plurality of link lines 280 may be formed of a transparent conductive material which is the same as a material which forms the plurality of touch lines 230 disposed in the active area AA, but is not limited thereto. Therefore, the plurality of link lines may include an opaque material having a low resistance, such as molybdenum (Mo), silver (Ag), titanium (Ti), copper (Cu), or aluminum (Al).

In one exemplary embodiment, each of the plurality of routing lines 270 and each of the plurality of link lines 280 may be electrically connected by the line connection part. For example, one end of each of the plurality of link lines 280 includes a recess (or a groove, a dented portion, or a trench) which is at least partially dented and the routing line 270 and the link line 280 may be electrically connected by the line connection part disposed so as to overlap the recess. This will be described in more detail with reference to FIGS. 7 to 13.

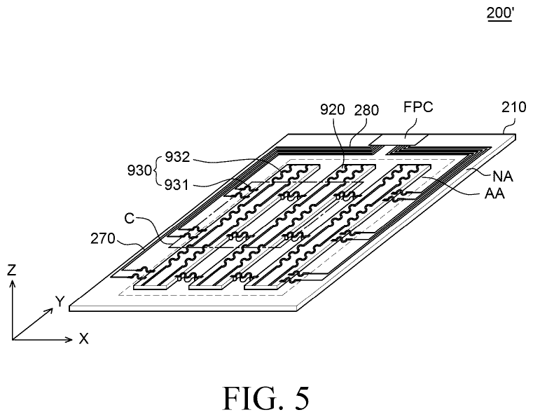

FIG. 5 is a perspective view illustrating another example of a touch panel included in a display device of FIG. 1 according to one embodiment.

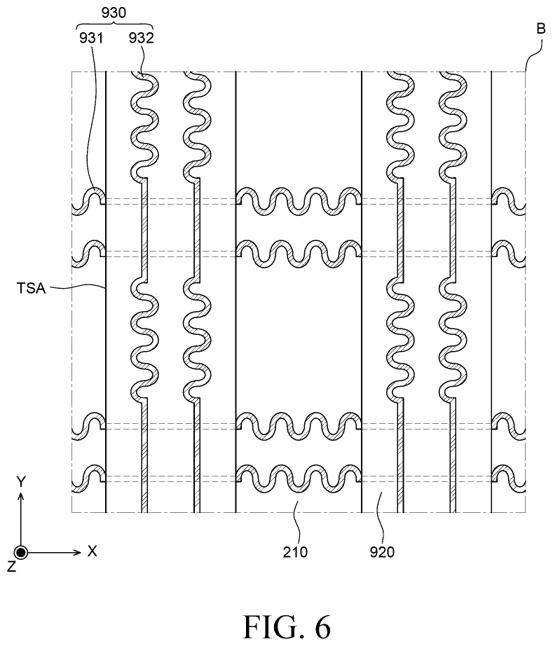

FIG. 6 is an enlarged plan view illustrating an example of a part C of FIG. 5 according to one embodiment.

In the meantime, a touch panel 200′ illustrated in FIGS. 5 and 6 is substantially same as or similar to the touch panel 200 which has been described with reference to FIGS. 3 and 4 except for a placement of the touch sensing film 920 and a placement of the touch line 930 so that a redundant description will not be repeated.

Referring to FIGS. 5 and 6, the touch panel 200′ according to another exemplary embodiment of the present disclosure may include a base substrate 210, a plurality of touch sensing films 920 disposed on the base substrate 210, a plurality of touch lines 930, a plurality of routing lines 270, and a plurality of link lines 280. The plurality of touch lines 930 is disposed in the first direction X and the second direction Y on the base substrate 210 and the plurality of touch sensing films 920. The plurality of routing lines 270 is connected to the plurality of touch lines 930 to transmit a touch signal detected by the plurality of touch lines 930 and the plurality of link lines 280 connects the plurality of routing lines 270 and the touch circuit unit FPC.

The plurality of touch sensing films 920 extend along the second direction Y, for example, an extending direction of the plurality of second touch lines 932, on the base substrate 210 and for example, may be disposed to be spaced apart from each other with a predetermined interval in the first direction X, for example, an extending direction of the plurality of first touch lines 931. For example, the plurality of touch sensing films 920 may have a stripe shape extending in the second direction Y. For example, areas in which the touch sensing film 920 is disposed and areas in which the touch sensing film 920 is not disposed may be alternately disposed on the base substrate 210 along the second direction Y. However, the present disclosure is not limited thereto and the plurality of touch sensing films 920 may have a stripe shape extending along the first direction X, for example, a extending direction of the plurality of first touch lines 931, on the base substrate 210 and for example, may be disposed to be spaced apart from each other with a predetermined interval in the second direction Y, for example, an extending direction of the plurality of second touch lines 932.

As described above, when the touch sensing film 920 is disposed in a stripe shape, an intersecting area of the first touch line 931 and the second touch line 932 on an area where the touch sensing film 920 is disposed may be defined as the touch sensing area TSA. Here, the first touch line 931 and the second touch line 932 may have a straight line shape so as to correspond to the touch sensing area TSA and have a curved shape so as to correspond to an area which is not the touch sensing area TSA. That is, the second touch line 932 disposed on the stripe shaped touch sensing film 920 may have a shape in which a curved shape and a straight line shape are mixed.

As described above, when the touch sensing film 920 is disposed in a stripe shape, the touch panel 200′ may extend only in one specific direction (for example, the second direction Y in which the touch sensing film 920 extends). As described above, the touch sensing film 920 of the touch panel 200′ is disposed in different shapes to enable various designs of the touch panel 200′ according to a purpose of a user or a designer.

FIG. 7 is an enlarged plan view illustrating an example of a part D of FIG. 3 according to one embodiment.

Referring to FIGS. 3, 5, and 7, a plurality of routing lines 270 and a plurality of link lines 280 are disposed on the non-active area NA of the base substrate 210 of the touch panels 200 and 200′ and a plurality of line connection parts 290 for connecting each of the plurality of routing lines 270 and each of the plurality of link lines 280 may be disposed.

As described with reference to FIGS. 3 and 5, the plurality of routing lines 270 may have a curved shape. For example, the plurality of routing lines 270 may have a sine wave shape. However, the shape of the plurality of routing lines 270 is not limited thereto. For example, the plurality of routing lines 270 may extend in a zigzag pattern. Alternatively, the plurality of routing lines 270 may have various shapes, such as a plurality of rhombus-shaped substrates connected and extended at vertices. In the meantime, the number and the shape of the plurality of routing lines 270 illustrated in FIG. 7 are illustrative and the number and the shape of the plurality of routing lines 270 may vary depending on the design.

That is, the plurality of link lines 280 may have an elongated straight line shape. According to the exemplary embodiment, as illustrated in FIG. 7, a width (for example, a line width) of the plurality of link lines 280 may be larger than a width (for example, a line width) of the plurality of routing lines 270, but is not limited thereto.

In one exemplary embodiment, one end of each of the plurality of link lines 280 may include a recess (or a groove, a dented portion, or a trench) which is at least partially dented. For example, a recess of each of the plurality of link lines 280 may have a concave shape. However, it is not limited thereto and a recess of each of the plurality of link lines 280 may have various shapes, such as a polygonal shape including a rectangular shape or a triangular shape or a circular shape or a segment shape.

Each of the plurality of link lines 280 and each of the plurality of routing lines 270 may be electrically connected by the line connection part 290. In one exemplary embodiment, the line connection part 290 may include a main connection part which is connected to the routing line 270 and has a planar structure and at least one sub connection part which connects the main connection part and the link line 280 and has a curved line structure.

Therefore, when the touch panels 200 and 200′ (or the display device 1000) extends, a stretching stress which is applied to a connection part of the routing line 270 and the link line 280 which is disposed in the non-active area NA of the touch panels 200 and 200′ to transmit the touch signal to the touch circuit unit FPC and/or the routing line 270 may be dispersed or reduced. Accordingly, the stretching reliability of the touch panels 200 and 200′ and the display device 1000 including the same according to the exemplary embodiments of the present disclosure may be improved.

Further, as described above, unlike the routing line 270 having a curved shape, the link line 280 may have a straight line shape. For example, as illustrated in FIG. 7, in an area adjacent to an area in which the routing line 270 and the link line 280 are connected, the link line 280 may have a straight line shape extending along one direction (for example, a second direction Y). Therefore, unlike the exemplary embodiment of the present disclosure, when the routing line 270 and the link line 280 disposed in the non-active area NA of the touch panel are directly connected without having a separate line connection part, if the touch panel extends along a direction (for example, the first direction X) different from the extending direction (for example, the second direction Y) of the link line 280 in an area adjacent to an area in which the routing line 270 and the link line 280 are connected, a stretching stress applied to the connection part of the routing line 270 and the link line 280 and/or the routing line 270 may be increased. In contrast, in the touch panels 200 and 200′ according to the exemplary embodiments of the present disclosure and the display device 1000 including the same, the routing line 270 and the link line 280 may be connected by the line connection part 290. The line connection part 290 includes a main connection part which is connected to the routing line 270 and has a planar shape and a plurality of sub connection parts which connects the main connection part and the link line 280 and has a curved line structure and extends in different directions. Accordingly, even though the touch panels 200 and 200′ extend in various directions, rather than in one specific direction, the stretching stress applied to the connection part of the routing line 270 and the link line 280 and/or the routing line 270 may be dispersed so that the stretching reliability of the touch panels 200 and 200′ (or the display device 1000) may be ensured.

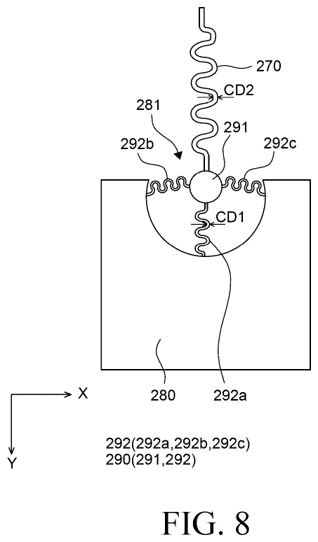

Hereinafter, various exemplary embodiments of the line connection part 290 will be described in more detail with reference to FIGS. 8 to 13.

FIG. 8 is a view for explaining an example of a line connection part included in a touch panel of FIG. 3 according to one embodiment.

Referring to FIGS. 3, 5, 7, and 8, the routing line 270 may extend along the second direction Y and have a curved shape and the link line 280 may extend along the second direction Y and have a straight line shape. According to the exemplary embodiment, as described with reference to FIG. 7, a width (for example, a line width) of the link line 280 may be larger than a width (for example, a line width) of the routing line 270.

In one exemplary embodiment, one end of the link line 280, for example, one end of the link line 280 corresponding to a side at which the link line 280 and the routing line 270 are connected may include a recess 281 (or a groove, a dented portion, or a trench) which is at least partially dented. For example, the recess 281 of the link line 280 may have a concave shape or a semi-circular shape.

The line connection part 290 may electrically connect the routing line 270 and the link line 280. For example, the line connection part 290 is disposed so as to correspond to the recess 281 of the link line 280, for example, is disposed so as to overlap the recess 281 to electrically connect the routing line 270 and the end of the link line 280.

To this end, in one exemplary embodiment, the line connection part 290 may include a main connection part 291 connected to the routing line 270 and at least one sub connection part 292 for connecting the main connection part 291 and the link line 280.

The main connection part 291 and at least one sub connection part 292 may include a conductive material. For example, the main connection part 291 and at least one sub connection part 292 may be formed of the same transparent conductive material as the material of the plurality of routing lines 270 and the plurality of link lines 280. However, the material is not limited thereto and the main connection part 291 and at least one sub connection part 292 may include an opaque conductive material having a low resistance, such as molybdenum (Mo), silver (Ag), titanium (Ti), copper (Cu), or aluminum (Al).

The main connection part 291 may have a planar structure. For example, the main connection part 291 is a pattern which is connected to the routing line 270 and at least one sub connection part 292 and may have a circular shape. However, the shape of the main connection part 291 is not limited thereto and may have various shapes, such as a semi-circular shape, an arch shape, a segment shape, or a polygonal shape.

According to the exemplary embodiment, the main connection part 291 may be disposed so as to correspond to a center portion of the recess 281 of the link line 280. For example, as illustrated in FIG. 8, when the recess 281 has a semicircular shape, the main connection part 291 may be disposed so as to correspond to a center point of the recess 281 having a semicircular shape. Accordingly, the line connection part 290 may be more stably connected to the routing line 270 and the link line 280.

At least one sub connection part 292 may have a curved line structure. For example, at least one sub connection part 292 may have a sine wave shape. However, the shape of at least one sub connection part 292 is not limited thereto. For example, at least one sub connection part 292 may extend in a zigzag pattern. Alternatively, at least one sub connection part 292 may have various shapes, such as a plurality of rhombus-shaped substrates connected and extended at vertices.

In one exemplary embodiment, the main connection part 291 may be connected to the link line 280 by the plurality of sub connection parts 292. For example, as illustrated in FIG. 8, the main connection part 291 may be connected by the plurality of sub connection parts 292 which extends in different directions.

For example, the sub connection part 292 may include three sub connection parts 292a, 292b, and 292c. To be more specific, the sub connection part 292 may include a first sub connection part 292a which extends along the extending direction of the routing line 270, for example, the second direction Y and second and third sub connection parts 292b and 292c extending generally along the first direction X. According to the exemplary embodiment, the second sub connection part 292b and the third sub connection part 292c may be symmetric to each other with respect to the second direction Y, that is, the first sub connection part 292a.

As described above, the main connection part 291 connected to the routing line 270 is connected to the link line 280 by the plurality of sub connection parts 292a, 292b, and 292c which extends in different directions so that the routing line 270 and the link line 280 may be more stably connected by the line connection part 290.

However, the number of sub connection parts 292 is just illustrative and the exemplary embodiment of the present disclosure is not limited thereto. For example, the sub connection part 292 may have two sub connection parts 292 or four or more sub connection parts 292.

In one exemplary embodiment, a width (for example, a first line width CD1) of the sub connection part 292 may be smaller than a width (for example, a second line width CD2) of the routing line 270. For example, the second line width CD2 of the plurality of routing lines 270 may be approximately 11.6 μm and the first line width CD1 of the plurality of sub connection parts 292 may be approximately 7 μm, but is not limited thereto. As described above, when the sub connection part 292 has a relatively small width (for example, a line width), the stretchability of the sub connection part 292 may be improved. Accordingly, when the touch panels 200 and 200′ (or the display device 1000) extend, the stretching stress applied to the connection part of the routing line 270 and the link line 280 may be more effectively dispersed.

In one exemplary embodiment, a length ratio of the sub connection part 292 may be smaller than a length ratio of the routing line 270. Here, the length ratio may be defined by a ratio of a length of a wiring line having a curved shape in a non-stretched state (for example, a distance between both ends of the corresponding wiring line in a non-stretched state in which a force is not applied to the corresponding wiring line to have a curved shape) and a length of the wiring line in a maximum stretched state (for example, a distance between both ends of the wiring line which is deformed to have a straight line shape according to the maximum stretched when the force is applied to the corresponding wiring line to be extended). For example, the smaller the length ratio, the fewer times the wiring line is bent. For example, the length ratio of the plurality of routing lines 270 may be approximately 2.33 and the length ratio of the plurality of sub connection parts 292 may be approximately 1.86, but are not limited thereto.

In the meantime, the larger the length ratio of the sub connection part 292, the better the stretchability of the sub connection part 292. In this case, when the touch panels 200 and 200′ (or the display device 1000) extend, the stretching stress applied to the connection part of the routing line 270 and the link line 280 may be more effectively dispersed. Accordingly, the length ratio of the sub connection part 292 is smaller than the length ratio of the routing line 270 and the sub connection part 292 may be manufactured to allow the sub connection part 292 to have the maximum length ratio which is allowed by the design.

However, the length ratio is not limited thereto and the length ratio of the sub connection part 292 may be designed in various forms. For example, the length ratio of the sub connection part 292 may be designed to be larger than a length ratio of the routing line 270.

Accordingly, the main connection part 291 and the sub connection part 292 may be integrally formed. For example, the main connection part 291 and the sub connection part 292 include the same material to be integrally formed.

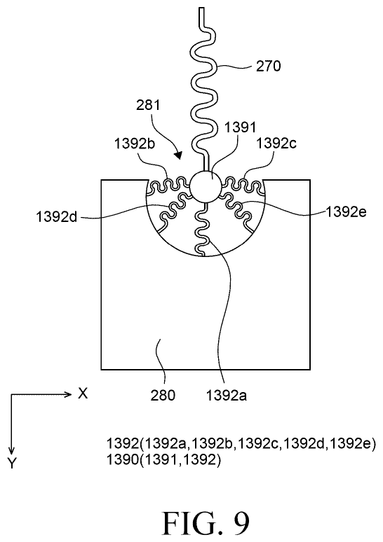

FIG. 9 is a view for explaining another example of a line connection part included in a touch panel of FIG. 3 according to one embodiment.

In the meantime, the line connection part 1390 of FIG. 9 is a modified exemplary embodiment of the line connection part 290 which has been described with reference to FIG. 8, with regard to the number of sub connection parts 1392 included in the line connection part 1390. Accordingly, a redundant description will not be repeated.

Referring to FIG. 9, in one exemplary embodiment, the line connection part 1390 may include a main connection part 1391 connected to the routing line 270 and at least one sub connection part 1392 for connecting the main connection part 1391 and the link line 280.

In one exemplary embodiment, the main connection part 1391 may be connected to the link line 280 by the plurality of sub connection parts 1392. For example, as illustrated in FIG. 9, the main connection part 1391 may be connected by the plurality of sub connection parts 1392 which extends in different directions.

For example, the sub connection part 1392 may include five sub connection parts 1392a, 1392b, 1392c, 1392d, and 1392e. To be more specific, the sub connection part 1392 may include a first sub connection part 1392a extending along an extending direction of the routing line 270, for example, the second direction Y, second and third sub connection parts 1392b and 1392c entirely extending along the first direction X, a fourth sub connection part 1392d disposed between the first sub connection part 1392a and the second sub connection part 1392b, and a fifth sub connection part 1392e disposed between the first sub connection part 1392a and the third sub connection part 1392c.

According to the exemplary embodiment, the second sub connection part 1392b and the third sub connection part 1392c may be symmetric to each other with respect to the second direction Y, that is, the first sub connection part 1392a.

Further, the fourth sub connection part 1392d may extend along a diagonal direction between an extending direction of the first sub connection part 1392a (for example, the second direction Y) and an extending direction of the second sub connection part 1392b (for example, an opposite direction to the first direction X). Similarly, the fifth sub connection part 1392e may extend along a diagonal direction between the extending direction of the first sub connection part 1392a (for example, the second direction Y) and an extending direction of the third sub connection part 1392c (for example, the first direction X).

According to the exemplary embodiment, the fourth sub connection part 1392d and the fifth sub connection part 1392e may be symmetric to each other with respect to the second direction Y, that is, the first sub connection part 1392a.

As described above, the main connection part 1391 connected to the routing line 270 is connected to the link line 280 by the plurality of sub connection parts 1392a, 1392b, 1392c, 1392d, and 1392e which extends in different directions so that the routing line 270 and the link line 280 may be more stably connected by the line connection part 1390.

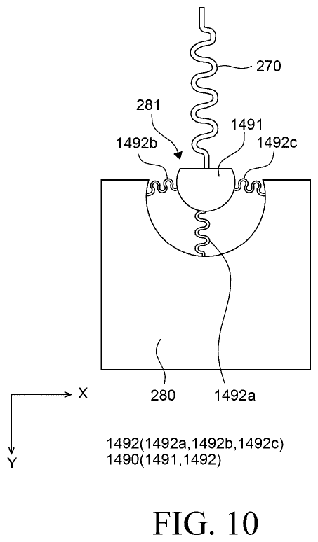

FIG. 10 is a view for explaining still another example of a line connection part included in a touch panel of FIG. 3.

In the meantime, the line connection part 1490 of FIG. 10 is a modified embodiment of the line connection part 290 which has been described with reference to FIG. 8, with regard to the shape of the main connection part 1491 included in the line connection part 1490. Accordingly, a redundant description will not be repeated.

Referring to FIG. 10, in one exemplary embodiment, the line connection part 1490 may include a main connection part 1491 connected to the routing line 270 and at least one sub connection part 1492 for connecting the main connection part 1491 and the link line 280. In the meantime, as described above, the sub connection part 1492 may include a plurality of sub connection parts 1492a, 1492b, and 1492c extending in different directions.

The main connection part 1491 may have a planar structure. For example, the main connection part 1491 is a pattern which is connected to the routing line 270 and at least one sub connection part 1492 and may have an arch shape. However, the shape of the main connection part 1491 is not limited thereto and the shape of the main connection part 1491 may vary in various forms.

In the meantime, in the exemplary embodiment of FIG. 10, the size of the main connection part 1491 may be designed to be larger than the size of the main connection part 291 which has been described with reference to FIG. 8. In this case, the main connection part 1491 and the routing line 270 may be more stably connected.

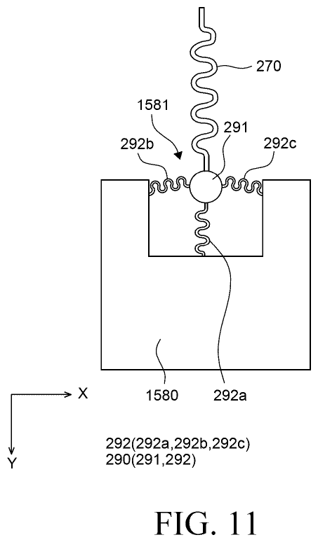

FIG. 11 is a view for explaining still another example of a line connection part included in a touch panel of FIG. 3.

In the meantime, the exemplary embodiment of FIG. 11 is a modified embodiment of the link line 280 which has been described with reference to FIG. 8, with regard to the shape of the recess 1581 of the link line 1580. Accordingly, a redundant description will not be repeated.

Referring to FIG. 11, one end of the link line 1580, for example, one end of the link line 1580 corresponding to a side at which the link line 1580 and the routing line 270 are connected may include a recess 1581 (or a groove, a dented portion, or a trench) which is at least partially dented. For example, as illustrated in FIG. 11, the recess 1581 of the link line 1580 may have a quadrangular shape. However, the shape of the recess 1581 is not limited thereto and may vary in various forms.

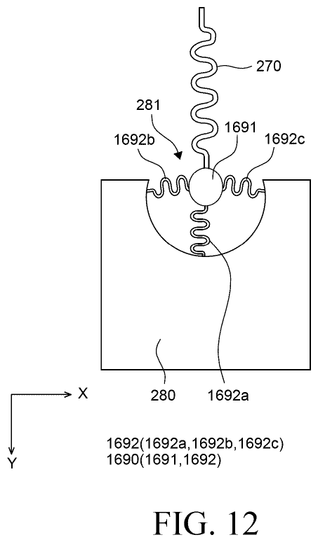

FIG. 12 is a view for explaining still another example of a line connection part included in a touch panel of FIG. 3 according to one embodiment.

In the meantime, the line connection part 1690 of FIG. 12 is a modified embodiment of the line connection part 290 which has been described with reference to FIG. 8, with regard to the length ratio of a sub connection part 1692 included in the line connection part 1690. Accordingly, a redundant description will not be repeated.

Referring to FIG. 12, in one exemplary embodiment, the line connection part 1690 may include a main connection part 1691 connected to the routing line 270 and at least one sub connection part 1692 for connecting the main connection part 1691 and the link line 280.

As described above, at least one sub connection part 1692 may have a curved line structure and the main connection part 1691 may be connected to the link line 280 by the plurality of sub connection parts 1692. For example, as illustrated in FIG. 12, the main connection part 1691 may be connected by the plurality of sub connection parts 1692a, 1692b, and 1692c which extends in different directions.

In one exemplary embodiment, the length ratio of the sub connection part 1692 is smaller than the length ratio of the routing line 270 and as described above with reference to FIG. 8, the sub connection part 1692 may be manufactured to allow the sub connection part 1692 to have the maximum length ratio which is allowed by the design. For example, in the exemplary embodiment of FIG. 12, the length ratio of the sub connection part 1692 may be larger than the length ratio of the sub connection part 292 which has been described with reference to FIG. 8. For example, when the sub connection parts 292 and 1692 having the curved shape in FIGS. 8 and 12 have sine wave shapes, the amplitude of the sine wave shape of the sub connection part 1692 of FIG. 12 may be larger than the amplitude of the sine wave shape of the sub connection part 292 of FIG. 8. For example, the length ratio of the plurality of routing lines 270 may be approximately 2.33 and the length ratio of the plurality of sub connection parts 1692 may be approximately 2.26. As described above, when the plurality of sub connection parts 1692 has the maximum length ratio which is allowed by the design, the stretchability of the sub connection part 1692 is improved so that when the touch panels 200 and 200′ (or the display device 1000) extend, the stretching stress applied to the connection part of the routing line 270 and the link line 280 may be more effectively dispersed.

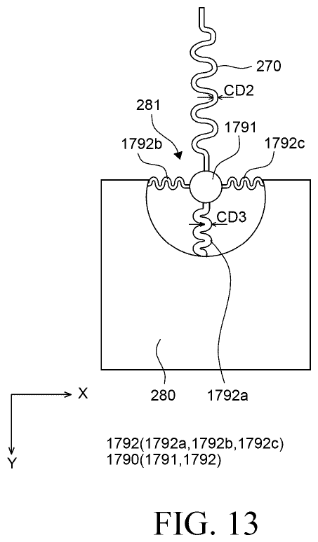

FIG. 13 is a view for explaining still another example of a line connection part included in a touch panel of FIG. 3 according to one embodiment.

In the meantime, the line connection part 1790 of FIG. 13 is a modified embodiment of the line connection part 290 which has been described with reference to FIG. 8, with regard to a width (for example, a third line width CD3) of a sub connection part 1792 included in the line connection part 1790. Accordingly, a redundant description will not be repeated.

Referring to FIG. 13, in one exemplary embodiment, the line connection part 1790 may include a main connection part 1791 connected to the routing line 270 and at least one sub connection part 1792 for connecting the main connection part 1791 and the link line 280. In the meantime, as described above, the sub connection part 1792 may include a plurality of sub connection parts 1792a, 1792b, and 1792c extending in different directions.

In one exemplary embodiment, a width (for example, a third line width CD3) of the sub connection part 1792 may be larger than a width (for example, a second line width CD2) of the routing line 270. For example, the second line width CD2 of the plurality of routing lines 270 may be approximately 11.6 μm and the third line width CD3 of the plurality of sub connection parts 1792 may be approximately 15 μm, but are not limited thereto. As described above, when the sub connection part 1792 has a relatively large width (for example, a line width), the durability of the sub connection part 1792 may be improved. Accordingly, the line connection part 1790 may be more stably connected to the routing line 270 and the link line 280.

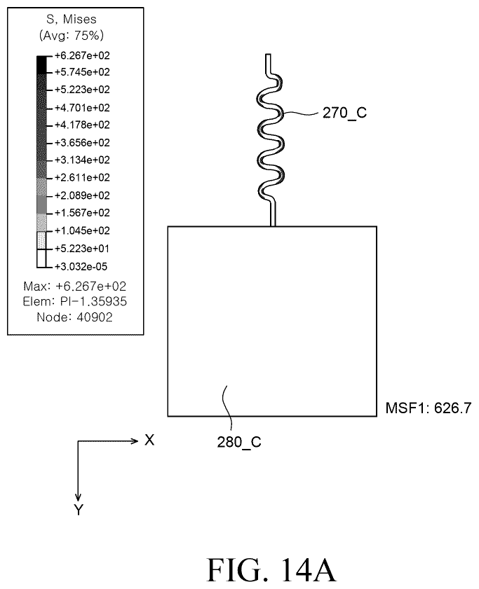

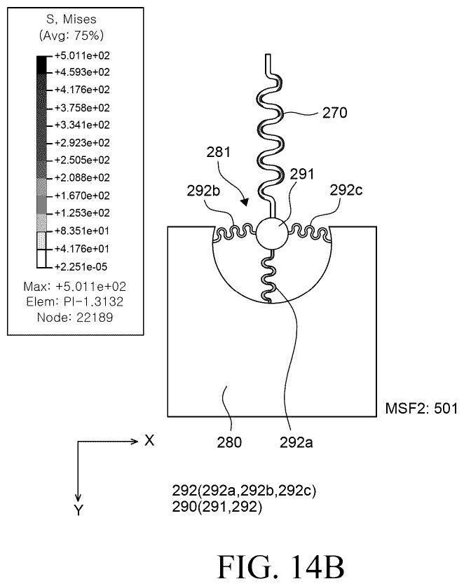

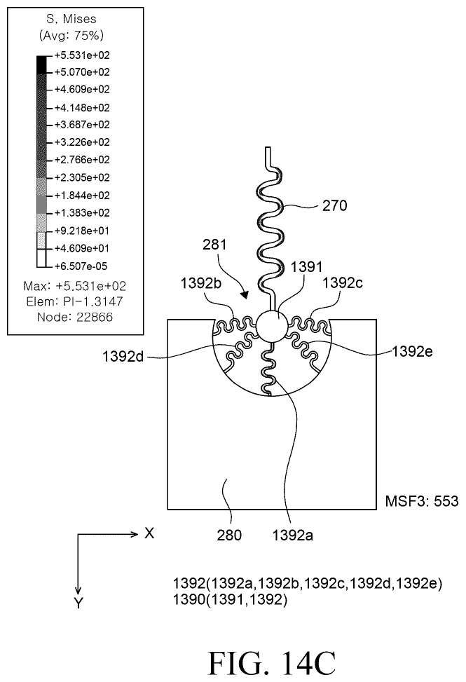

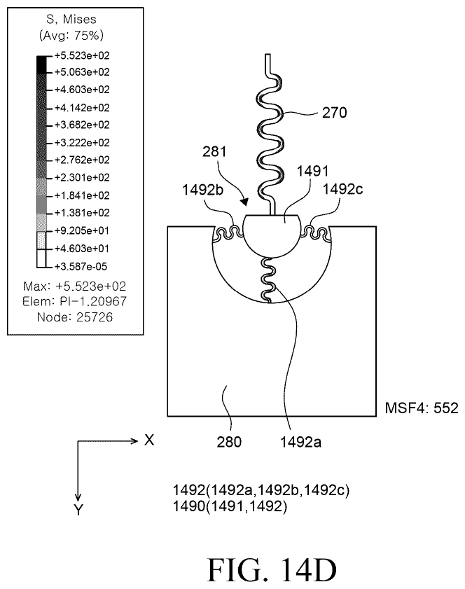

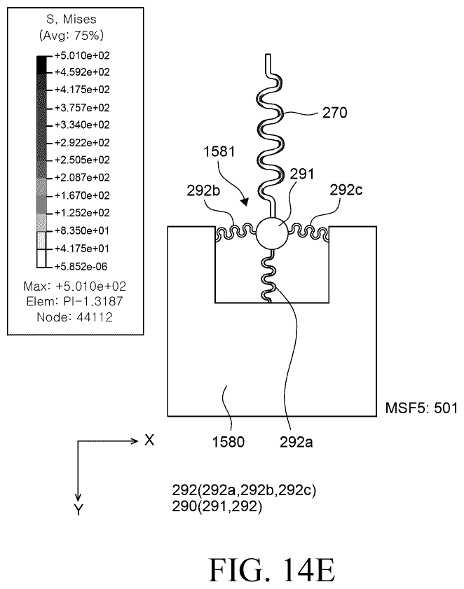

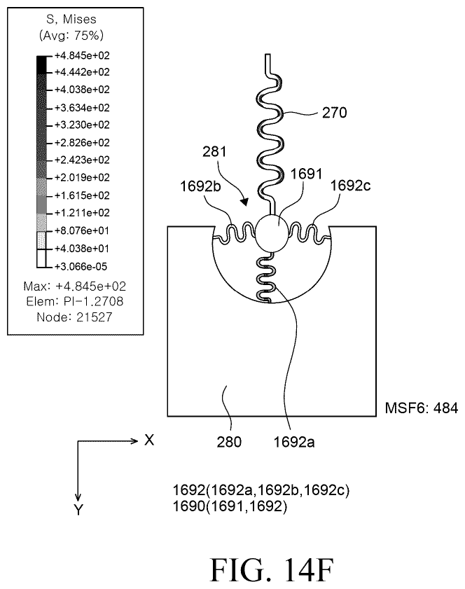

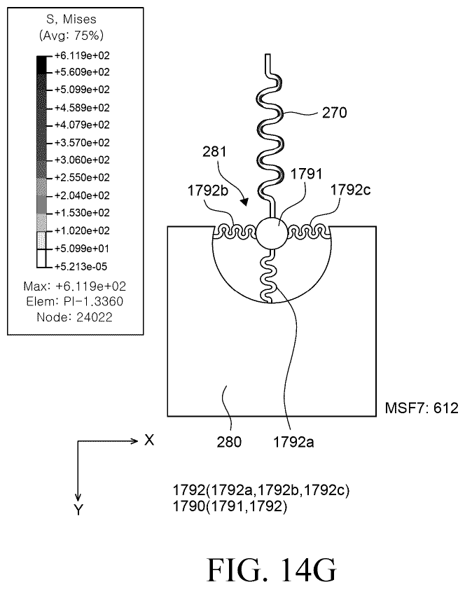

FIGS. 14A to 14G are views for explaining examples of a stretching stress applied to a routing line included in a touch panel when a display device according to exemplary embodiments of the present disclosure is stretched.

In the meantime, FIG. 14A illustrates a maximum stretching stress MSF1 applied to the routing line 270_C together with the stretching stress (denoted by “S, Mises”) applied to the routing line 270_C and the link line 280_C included in the touch panel when a touch panel according to a comparative embodiment of the present disclosure is stretched (for example, a tension along the second direction Y is applied to the routing line 270_C).

In the meantime, FIGS. 14B to 14G illustrate maximum stretching stresses MSF2 to MSF7 applied to the routing line 270 together with the stretching stress (denoted by “S, Mises”) applied to the routing line 270 and the link line 280 included in the touch panels 200 and 200′ when the touch panels 200 and 200′ according to various exemplary embodiments of the present disclosure are stretched (for example, a tension along the second direction Y is applied to the routing line 270). For example, FIGS. 14B to 14G illustrate a stretching stress when the touch panels 200 and 200′ including the line connection parts 290, 1390, 1490, 1690, and 1790, which have been described with reference to FIGS. 8 to 13 are stretched.

First, referring to FIG. 14A, the touch panel according to the comparative embodiment of the present disclosure in which the routing line 270_C and the link line 280_C are directly connected without including a separate line connection part which has been described with reference to FIGS. 7 to 13 will be described as an example. When the tension along the second direction Y is applied to the routing line 270_C to stretch the touch panel, the maximum stretching stress MSF1 applied to the routing line 270_C may be approximately 626.7.

In contrast, referring to FIGS. 14B to 14G, when the routing line 270 and the link lines 280 and 1580 are connected by the line connection parts 290, 1390, 1490, 1690, and 1790 which have been described with reference to FIGS. 7 to 13, as compared with the comparative embodiment of the present disclosure in which the routing line 270_C and the link line 280_C are directly connected without a separate connection part, the maximum stretching stresses MSF2 to MSF7 applied to the routing line 270 may have a relatively small value.

For example, referring to FIG. 14B, when the routing line 270 and the link line 280 are connected by the line connection part 290 as described with reference to FIG. 8, when the tension along the second direction Y is applied to the routing line 270 to stretch the touch panels 200 and 200′, the maximum stretching stress MSF2 applied to the routing line 270 may be approximately 501.

For example, referring to FIG. 14C, when the routing line 270 and the link line 280 are connected by the line connection part 1390 as described with reference to FIG. 9, when the tension along the second direction Y is applied to the routing line 270 to stretch the touch panels 200 and 200′, the maximum stretching stress MSF3 applied to the routing line 270 may be approximately 553.

For example, referring to FIG. 14D, when the routing line 270 and the link line 280 are connected by the line connection part 1490 as described with reference to FIG. 10, when the tension along the second direction Y is applied to the routing line 270 to stretch the touch panels 200 and 200′, the maximum stretching stress MSF4 applied to the routing line 270 may be approximately 552.

For example, referring to FIG. 14E, when the routing line 270 and the link line 1580 are connected by the line connection part 290 as described with reference to FIG. 11, when the tension along the second direction Y is applied to the routing line 270 to stretch the touch panels 200 and 200′, the maximum stretching stress MSF5 applied to the routing line 270 may be approximately 501.

For example, referring to FIG. 14F, when the routing line 270 and the link line 280 are connected by the line connection part 1690 as described with reference to FIG. 12, when the tension along the second direction Y is applied to the routing line 270 to stretch the touch panels 200 and 200′, the maximum stretching stress MSF6 applied to the routing line 270 may be approximately 484.

For example, referring to FIG. 14G, when the routing line 270 and the link line 280 are connected by the line connection part 1790 as described with reference to FIG. 13, when the tension along the second direction Y is applied to the routing line 270 to stretch the touch panels 200 and 200′, the maximum stretching stress MSF7 applied to the routing line 270 may be approximately 612.

In the meantime, as illustrated in FIGS. 14B to 14G, the larger the stretchability of the sub connection parts 292, 1392, 1492, 1692, and 1792 included in the line connection parts 290, 1390, 1490, 1690, and 1790, the more effectively the stretching stress applied to the connection part of the routing line 270 and the link line 280 is dispersed. Therefore, the maximum stretching stress applied to the routing line 270 may be reduced.

For example, as described with reference to FIGS. 8 to 13, the smaller the number of sub connection parts 292, 1392, 1492, 1692, and 1792, the longer the length of the sub connection parts 292, 1392, 1492, 1692, and 1792, the larger the length ratio of the sub connection parts 292, 1392, 1492, 1692, and 1792, and/or the smaller the width of the sub connection parts 292, 1392, 1492, 1692, and 1792, the better the stretchability of the sub connection parts 292, 1392, 1492, 1692, and 1792. Therefore, as illustrated in FIGS. 14B to 14G, the maximum stretching stress MSF2 to MSF7 has small values so that the stretching reliability of the touch panels 200 and 200′ (or the display device 1000) may be further improved.

As described above, in the touch panel according to the exemplary embodiments of the present disclosure and the display device including the same, a routing line and a link line which are disposed in a non-active area of the touch panel to transmit a touch signal to a touch circuit unit are connected by a line connection part including a main connection part and at least one sub connection part. The main connection part is connected to the routing line and has a planar structure, and the sub connection part connects the main connection part and the link line and has a curved line structure. Therefore, when the touch panel and the display device including the same are stretched, a stretching stress applied to the connection part of the routing line and the link line and/or the routing line may be distributed or reduced. Accordingly, the stretching reliability of the touch panel and the display device including the same according to the exemplary embodiments of the present disclosure may be improved.

Further, in the touch panel according to the exemplary embodiments of the present disclosure and the display device including the same, the routing line and the link line may be connected by a line connection part. The line connection part includes a main connection part which is connected to the routing line and has a planar structure and a plurality of sub connection parts which connects the main connection part and the link line and has a curved line structure, and extends in different directions. Accordingly, even though the touch panel is stretched in various directions, rather than a specific one direction, the stretching stress to be applied to the connection part of the routing line and the link line and/or the routing line may be dispersed so that the stretching reliability of the touch panel and the display device including the same may be ensured.

The touch panel according to various exemplary embodiments of the present disclosure will be described as follows:

In order to achieve the object as described above, a touch panel according to an exemplary embodiment of the present disclosure may include a base substrate including an active area and a non-active area excluding the active area, a plurality of touch sensing films which is disposed on the active area of the base substrate and is disposed so as to correspond to a touch sensing area, a plurality of touch lines which is disposed on the active area of the base substrate and at least partially overlaps the plurality of touch sensing films, a plurality of routing lines which is disposed on the non-active area of the base substrate and is connected to the plurality of touch lines, and a plurality of link lines which is disposed on the non-active area of the base substrate and connects the plurality of routing lines and a touch circuit unit and an end of each of the plurality of link lines may include a recess which is at least partially dented.

In one exemplary embodiment, the touch panel may further include a line connection part which overlaps the recess and connects one end of each of the plurality of link lines and each of the plurality of routing lines.

In one exemplary embodiment, the line connection part may include a main connection part which is connected to each of the plurality of routing lines and at least one sub connection part which connects the main connection part and one end of each of the plurality of link lines.

In one exemplary embodiment, the main connection part may have a planar structure and at least one sub connection part may have a curved line structure.

In one exemplary embodiment, the main connection part may have a circular shape.

In one exemplary embodiment, the main connection part may have an arch shape.

In one exemplary embodiment, at least one sub connection part may include a first sub connection part which extends along a second direction along which the plurality of routing lines extends; a second sub connection part extending along a first direction which is different from the second direction; and a third sub connection part which is symmetric to the second sub connection part with respect to the second direction.

In one exemplary embodiment, at least one sub connection part may further include a fourth sub connection part disposed between the first sub connection part and the second sub connection part and a fifth sub connection part which is symmetric to the fourth sub connection part with respect to the second direction.

In one exemplary embodiment, a length ratio of at least one sub connection part is smaller than a length ratio of each of the plurality of routing lines and the length ratio may be defined by a ratio of a length in a non-stretched state and a length in a maximum stretched state.

In one exemplary embodiment, a width of at least one sub connection part may be smaller than a width of each of the plurality of routing lines.

In one exemplary embodiment, a width of at least one sub connection part may be larger than a width of each of the plurality of routing lines.

In one exemplary embodiment, the recess may have a concave shape.

In one exemplary embodiment, the recess may have a quadrangular shape.

In one exemplary embodiment, the plurality of touch lines may include a first touch line which is disposed on the active area of the base substrate in a first direction and a second touch line which is disposed on the active area of the base substrate in a second direction which is different from the first direction and each of the plurality of touch sensing films may be interposed between the first touch line and the second touch line.

In one exemplary embodiment, the plurality of routing lines may be disposed in the non-active area on a first side of the active area and a second side which is opposite to the first side and the plurality of link lines may be disposed in the non-active area on a third side between the first side and the second side of the active area.

In order to achieve the object as described above, a touch panel according to an exemplary embodiment of the present disclosure may include a base substrate including an active area and a non-active area excluding the active area, a plurality of touch sensing films which is disposed on the active area of the base substrate and is disposed so as to correspond to a touch sensing area, a plurality of touch lines which is disposed on the active area of the base substrate and at least partially overlaps the plurality of touch sensing films, a plurality of routing lines which is disposed on the non-active area of the base substrate and is connected to the plurality of touch lines, a plurality of link lines which is disposed on the non-active area of the base substrate and connects the plurality of routing lines and a touch circuit unit, and a line connection part which connects one end of each of the plurality of link lines and each of the plurality of routing lines. The line connection part may include a main connection part which is connected to each of the plurality of routing lines and at least one sub connection part which connects the main connection part and one end of each of the plurality of link lines.

In order to achieve the object as described above, a display panel including a flexible lower substrate and a plurality of plate patterns which is rigider than the lower substrate and disposed on the lower substrate to be spaced apart from each other and a touch panel which is disposed on the display panel and includes a plurality of touch lines, a plurality of routing lines connected to the plurality of touch lines, and a plurality of link lines which connects the plurality of routing lines and a touch circuit unit. An end of each of the plurality of link lines includes a recess which is at least partially dented.

Although the exemplary embodiments of the present disclosure have been described in detail with reference to the accompanying drawings, the present disclosure is not limited thereto and may be embodied in many different forms without departing from the technical concept of the present disclosure. Therefore, the exemplary embodiments of the present disclosure are provided for illustrative purposes only but not intended to limit the technical concept of the present disclosure. The scope of the technical concept of the present disclosure is not limited thereto. Therefore, it should be understood that the above-described exemplary embodiments are illustrative in all aspects and do not limit the present disclosure. The protective scope of the present disclosure should be construed based on the following claims, and aAll the technical concepts in the equivalent scope of the present disclosure thereof should be construed as falling within the scope of the present disclosure.

What is claimed is:

1. A touch panel, comprising:
a base substrate including an active area and a non-active area excluding the active area;
a plurality of touch sensing films on the active area of the base substrate, the plurality of touch sensing films disposed to correspond to a touch sensing area;
a plurality of touch lines on the active area of the base substrate, the plurality of touch lines at least partially overlapping the plurality of touch sensing films;
a plurality of routing lines on the non-active area of the base substrate, the plurality of routing lines connected to the plurality of touch lines; and
a plurality of link lines on the non-active area of the base substrate, the plurality of link lines connecting the plurality of routing lines and a touch circuit unit,
wherein an end of each of the plurality of link lines includes a recess that is at least partially dented.

2. The touch panel according to claim 1, further comprising:
a line connection part that overlaps the recess and connects one end of each of the plurality of link lines and each of the plurality of routing lines.

3. The touch panel according to claim 2, wherein the line connection part includes:
a main connection part that is connected to each of the plurality of routing lines; and
at least one sub connection part that connects the main connection part and one end of each of the plurality of link lines.

4. The touch panel according to claim 3, wherein the main connection part has a planar structure and the at least one sub connection part has a curved line structure.

5. The touch panel according to claim 3, wherein the main connection part has a circular shape.

6. The touch panel according to claim 3, wherein the main connection part has an arch shape.

7. The touch panel according to claim 3, wherein the at least one sub connection part includes:
a first sub connection part that extends along a second direction along which the plurality of routing lines extends;
a second sub connection part extending along a first direction that is different from the second direction; and
a third sub connection part that is symmetric to the second sub connection part with respect to the second direction.

8. The touch panel according to claim 7, wherein the at least one sub connection part further includes:
a fourth sub connection part between the first sub connection part and the second sub connection part; and
a fifth sub connection part that is symmetric to the fourth sub connection part with respect to the second direction.

9. The touch panel according to claim 3, wherein a length ratio of the at least one sub connection part is smaller than a length ratio of each of the plurality of routing lines and the length ratio is defined by a ratio of a length in a non-stretched state and a length in a maximum stretched state.

10. The touch panel according to claim 3, wherein a width of the at least one sub connection part is smaller than a width of each of the plurality of routing lines.

11. The touch panel according to claim 3, wherein a width of the at least one sub connection part is larger than a width of each of the plurality of routing lines.

12. The touch panel according to claim 1, wherein the recess has a concave shape.

13. The touch panel according to claim 1, wherein the recess has a quadrangular shape.

14. The touch panel according to claim 1, wherein the plurality of touch lines include:
a first touch line on the active area of the base substrate in a first direction;
a second touch line on the active area of the base substrate in a second direction that is different from the first direction,
wherein each of the plurality of touch sensing films is interposed between the first touch line and the second touch line.

15. The touch panel according to claim 1, wherein the plurality of routing lines are the non-active area on a first side of the active area and a second side which is opposite to the first side and the plurality of link lines are in the non-active area on a third side between the first side and the second side of the active area.

16. A touch panel, comprising:
a base substrate including an active area and a non-active area excluding the active area;
a plurality of touch sensing films on the active area of the base substrate, the plurality of touch sensing films disposed so as to correspond to a touch sensing area;
a plurality of touch lines on the active area of the base substrate, the plurality of touch lines at least partially overlapping the plurality of touch sensing films;
a plurality of routing lines on the non-active area of the base substrate, the plurality of routing lines connected to the plurality of touch lines;
a plurality of link lines on the non-active area of the base substrate, the plurality of link lines connecting the plurality of routing lines and a touch circuit unit; and
a line connection part that connects one end of each of the plurality of link lines and each of the plurality of routing lines,
wherein the line connection part includes:
a main connection part that is connected to each of the plurality of routing lines; and
at least one sub connection part that connects the main connection part and one end of each of the plurality of link lines.

17. A display device, comprising:
a display panel including a flexible lower substrate and a plurality of plate patterns that are rigider than the flexible lower substrate and disposed on the flexible lower substrate to be spaced apart from each other; and
a touch panel on the display panel and includes a plurality of touch lines, a plurality of routing lines connected to the plurality of touch lines, and a plurality of link lines that connect the plurality of routing lines and a touch circuit unit,
wherein an end of each of the plurality of link lines includes a recess which is at least partially dented.
